(19) United States
(12) Patent Application Publication
(10) Pub. No.: US 2020/0082414 A1
(43) Pub. Date: Mar. 12, 2020

(54) System, Method, and Computer Program for Identifying Consumer Eyewear Purchasing Trends

(71) Applicant: EyeOn.pro Ltd., Timnath, CO (US)

(72) Inventors: Craig Dean Hanson, Elk Grove, CA (US); Paul Aaron DeVoe, Timnath, CO (US)

(21) Appl. No.: 16/126,885

(22) Filed: Sep. 10, 2018

(51) Int. Cl. G06Q 30/02; G06Q 30/06; G06Q 10/06

(52) U.S. Cl. CPC G06Q 30/0201; G06Q 10/06393; G06Q 30/0603

(57) ABSTRACT

The presently disclosed technology includes a system, method, and computer program product are provided for collection of consumer eyewear preference trending, consumer statistics, competitive eyewear purchasing comparison, consumer fashion personality, social feedback on eyewear, and consumer personal attributes related to eyewear purchasing.

### BACKGROUND

Eyewear sales in an optometric practice typically are an important revenue stream to the optometric practice. The practice of frame selection and purchasing by a patient is typically done while a patient is physically browsing through frame inventory. At that time, the patient may review the available physical inventory, select, and try on frames. In this environment tracking the consumer behavior, what they viewed, what they compared and their purchase habits are impossible to track and trend. As the optometric practice moves their physical inventory to digital selection there is an opportunity to capture and use deep trending information, comparison information and statistics.

### FIELD OF THE INVENTION

The present invention relates generally to obtaining and use of patient and consumer preference trending data in eyewear.

### SUMMARY

A system, method, and computer program product are provided for collection of consumer eyewear preference trending, consumer statistics, competitive eyewear purchasing comparison, consumer fashion personality, social feedback on eyewear, and consumer personal attributes related to eyewear purchasing.

### BRIEF DESCRIPTION OF THE DRAWINGS

FIG. 1 illustrates an exemplary system, in accordance with one embodiment.

FIG. 2 illustrates a network architecture, in accordance with one possible embodiment

FIG. 3 illustrates a method for collection and utilization of consumer eyewear preference trending, consumer statistics, competitive eyewear purchasing comparison, consumer fashion personality, social feedback on eyewear, and consumer personal attributes related to eyewear purchasing.

### DETAILED DESCRIPTION

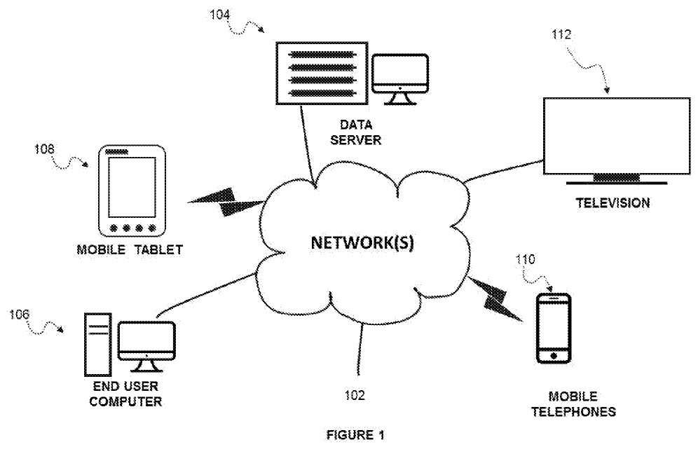

FIG. 1 illustrates a network architecture 100, in accordance with one possible embodiment. As shown, at least one network 102 is provided. In the context of the present network architecture 100, the network 102 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 102 may be provided.

Coupled to the network 102 is a plurality of devices. For example, a server computer 104 and an end user computer 106 may be coupled to the network 102 for communication purposes. Such end user computer 106 may include a desktop computer, lap-top computer, and/or any other type of logic. Still yet, various other devices may be coupled to the network 102 including a personal mobile tablet 108, a mobile phone device 110, a television 112, etc.

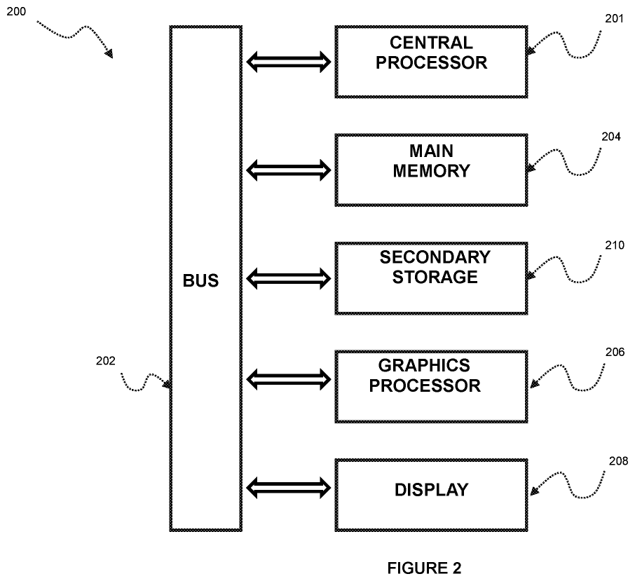

FIG. 2 illustrates an exemplary system 200, in accordance with one embodiment. As an option, the system 200 may be implemented in the context of any of the devices of the network architecture 100 of FIG. 1. Of course, the system 200 may be implemented in any desired environment.

As shown, a system 200 is provided including at least one central processor 201 which is connected to a communication bus 202. The system 200 also includes main memory 204 [e.g. random-access memory (RAM), etc.]. The system 200 also includes a graphics processor 206 and a display 208.

The system 200 may also include a secondary storage 210. The secondary storage 210 includes, for example, a hard disk drive and/or a removable storage drive, representing a floppy disk drive, a magnetic tape drive, a compact disk drive, etc. The removable storage drive reads from and/or writes to a removable storage unit in a well-known manner.

Computer programs, or computer control logic algorithms, may be stored in the main memory 204, the secondary storage 210, and/or any other memory, for that matter. Such computer programs, when executed, enable the system 200 to perform various functions (to be set forth below, for example). Memory 204, storage 210 and/or any other storage are possible examples of tangible computer-readable media.

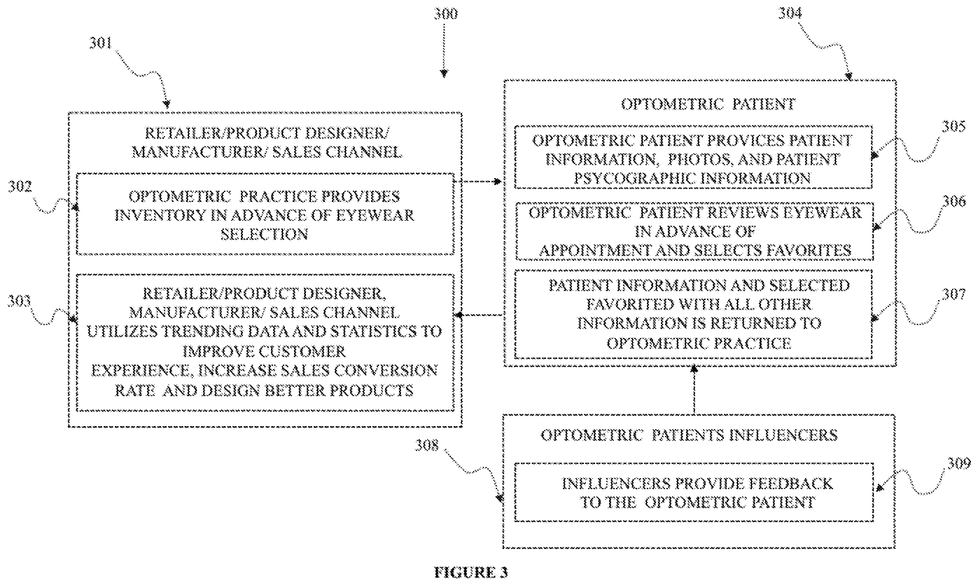

FIG. 3 illustrates a method 300 for enabling optometric patients to review available inventory, select eyewear favorites and provide personal information that will enhance the eyewear purchasing experience.

As an option, the method 300 may be carried out in the context of the details of FIGS. 1 and/or 2. Of course, however, the method 300 may be carried out in any desired environment. Further, the aforementioned definitions may equally apply to the description below.

As shown, one or more optometric practice 301 provides access to eyewear inventory to the consumer 302. At least one optometric patient 304 provides patient information, photos, and patient psychographic information. The optometric patient reviews eyewear in advance and selects favorites 306. The optometric patient Influencers 308 are any person or entity that can influence the purchasing decision for the optometric patient. The optometric patients' influencers 309 provide feedback to the optometric patient. Patient information 307 with the patient selected favorites and all other information are stored and returned to the optometric practice. The frame designer, manufacturer, or sales channel utilizes the data 303 to improve the design or competitive aspects or business practices.

1. A computer program product embodied on a non-transitory computer readable medium or mobile computing platform, comprising computer code for:
Identifying eyewear consumer preference, fashion, and sales trends on a local, regional, national and international level;
Providing optometric patient access to digitally delivered eyewear inventory who have a scheduled appointment with an optometric provider;
digitally storing the current eyewear inventory found in an optometric practice including both physical inventory or virtual inventory;
presenting the optometric practice's current eyewear inventory to patients on a mobile computing or internet-connected computing device;
receiving and storage of patient information, eyewear preferences, eyewear favorites and personal psychographic information;
Tracking consumer interactions with the application in a data storage mechanism;
Trending information is provided as statistics, graphic visualizations, raw data, mapped information or any other materialization.

2. The computer program product of claim 1, wherein the preferences, trends, social feedback, and trends allow for comparison to past performance and competitor's eyewear.

3. The computer program product of claim 1, wherein the optometric patient can also be a consumer who makes eyewear purchasing decisions. The terms patient and consumer are used interchangeably herein.

4. The computer program product of claim 1, purchase conversion rates are determined including but not limited to metrics such as “Consumer impression views per purchase”, “Consumer try-ons per purchase”, “Social media favorites per purchase”, “Social media posts per purchase”, “frames most compared with”. “Eyewear which consumers also viewed”, and “Eyewear which consumers also favorited”.

5. The computer program product of claim 1, wherein the consumer fashion personality information and consumer design style information and lifestyle are provided as information or statistics available with the trending data and statistics.

6. The computer program product of claim 1, wherein the consumer details including skin tonality, face shape, hair style and color are provided as information or statistics available with the trending data and statistics.

7. The computer program product of claim 1, wherein the frame designer, frame manufacturer, frame sales use the trending information or statistics to improve the product or product sales.

8. The computer program product of claim 1, wherein the optical practice or vision care practice uses the trending data and statistics to optimize their physical inventory and sales process.
